(19) United States
(12) Patent Application Publication
(10) Pub. No.: US 2005/0264226 A1
(43) Pub. Date: Dec. 1, 2005

(54) Method of driving an electron emission device

(76) Inventors: Duck-Gu Cho, Suwon-si (KR); Chul-Ho Lee, Suwon-si (KR)

Correspondence Address: MCGUIREWOODS, LLP, 1750 TYSONS BLVD, SUITE 1800, MCLEAN, VA, 22102, US

(21) Appl. No.: 11/139,628

(22) Filed: May 31, 2005

(30) Foreign Application Priority Data
May 31, 2004 (KR) 10-2004-0039249

(51) Int. Cl. G09G 3/10

(52) U.S. Cl. 315/169.1; 315/169.3

(57) ABSTRACT

Provided is a method for driving an electron emission device that reduces the required withstand voltage of an integrated circuit constituting a scan driver, which reduces both the manufacturing costs of an electron emission device and the likelihood of noise in the scan driver, as well as preventing back emission. Scan signals are applied to scan electrode lines during a scan period and an offset period, which is a non-scan period. Display data signals are applied to data electrode lines during a first data period, when a difference between a voltage of the display data signal and a voltage of the scan signal is greater than or equal to an emission start voltage; and during a second data period, when the voltage difference is less than the emission start voltage.

### CROSS-REFERENCE TO RELATED APPLICATION

This application claims the priority of Korean Patent Application No. 10-2004-0039249, filed on May 31, 2004, in the Korean Intellectual Property Office, the disclosure of which is incorporated in its entirety herein by reference.

### BACKGROUND OF THE INVENTION

1. Field of the Invention

The present invention relates to a method of driving an electron emission device, and more particularly, to a method of driving an electron emission device by which an offset voltage is applied to scan electrode lines of an electron emission panel during a non-scan period such that a required withstand voltage of an integrated circuit (IC) constituting a scan driver is reduced, thereby reducing both the manufacturing costs of an electron emission device and the likelihood of noise in the scan driver, as well as preventing back emission.

2. Description of the Related Art

A conventional electron emission device includes primarily an electron emission panel and a device for driving the electron emission panel. The electron emission panel includes gate electrodes, cathode electrodes disposed below the gate electrodes, and anode electrodes having phosphor cells formed thereon. In operation, a positive-polarity voltage is applied to gate electrodes and a negative-polarity voltage is applied to cathode electrodes, thereby creating a voltage difference between the gate electrodes and the cathode electrodes. When this voltage difference is equal to or larger than an emission start voltage, electrons are emitted from the cathode electrodes. The driving device applies a positive-polarity voltage to the anode electrodes, which accelerates the electrons toward the gate electrodes and the accelerated electrons collide with phosphor cells formed in front of the anode electrodes to emit light.

Alternatively, gate electrodes may be disposed below the cathode electrodes such that when the voltage difference between the gate and cathode electrodes is equal to or larger than the emission start voltage, the electrons emitted from the cathode electrodes are accelerated toward the anode electrodes. The gate electrodes may be used as scan electrodes and the cathode electrodes may be used as data electrodes and conversely, the gate electrodes may be used as the data electrodes and the cathode electrodes may be used as the scan electrodes, depending on the structure of an electron emission panel.

A gray-scale controlling method for adjusting the brightness of the electron emission panel may use either a pulse width modulation (PWM) to control the data signal's wavelength, or the time the signal is applied to the data electrodes, or pulse amplitude modulation (PAM) to control the data signal's amplitude, or the voltage of the signal applied to the data electrodes. Using either PWM or PAM, a data driver then processes a gray scale signal, which is included in an input data-driving control signal SD from a panel controller, and the data driver performs either PWM or PAM on a data driving signal and raises the data driving signal to a voltage that drives electrodes of an electron emission panel can be driven so that a display data signal is made and output to data electrode lines. The present invention is applied to both the PWM method and the PAM method.

FIG. 1 is a waveform diagram of signals applied to anode electrodes, data electrode lines, and scan electrode lines in a conventional method of driving an electron emission device.

In FIG. 1 at (a), V_{Anode} shows a voltage applied to anode electrodes disposed in an uppermost portion of an electron emission panel. A very strong positive-polarity voltage of 4 KV is continually applied to the anode electrodes, which in turn attract emitted electrons.

In FIG. 1 at (b) is a waveform diagram of a scan signal applied to scan electrode lines of an electron emission panel. The scan signal has a pulse voltage V_{Scan}, wherein a high-voltage pulse of 150V is applied to the scan electrode lines during a scan period from t₁ to t₃ and no voltage is applied during a non-scan, or offset, period.

In FIG. 1 at (c) is a waveform diagram of a display data signal applied to data electrode lines of an electron emission panel. The display data signal has a pulse voltage V_{Data}, wherein no voltage is applied to the data line at first data period t₁ to t₂ at the beginning of the scan period, and a voltage of 70V is applied at a second data period t₂ to t₃ at the end of the scan period.

FIG. 1 at (d) simultaneously shows both the waveform of the scan signal from (b) and the waveform of the display data signal from (c). An emission start voltage Vₜₕ, which is the difference between the voltages of the scan signal and the display data signal (V_{scan}−V_{data}), is the voltage at which electron emission begins. During the first data period (t₁ to t₂), or on period, the difference between V_{Data} (0V) and V_{scan} (150V) exceeds the emission start voltage Vₜₕ. During the second data period (t₂ to t₃), or off period, the difference between V_{Data} (70V) and V_{scan} (150V) is less than the emission start voltage Vₜₕ.

For example, if the voltage difference at which a sufficient amount of electrons can be emitted from the electron emission panel is 150V and an emission start voltage is 120V, then sufficient electron emission occurs during the scan period when the voltage of the display data signal is 0V and the voltage of the scan signal is 150V. However, electron emission does not occur during the period when the voltage of the display data signal is 70V (or equal to or larger than 30V, i.e., so that the voltage difference is less than the emission start voltage) and the voltage of the scan signal is 150V. By performing PWM, and modulating the length of the period during which the voltage of the display data signal is 0V, or performing PAM, and modulating a pulse voltage difference (that is, a pulse amplitude) between the display data signal and the scan signal when that difference is greater than or equal to the emission start voltage, the density of electrons emitted is changed, and, thus, the brightness of light output from the electron emission panel is also changed.

Because the voltage for emitting the sufficient amount of electrons is 150V, the integrated circuit (IC) comprising the scan driver should have a withstand voltage of at least 120% of 150V, which is 180V. However, since a scan driver having such a high withstand voltage is relatively expensive, the manufacturing costs of the electron emission device are substantially higher. In addition, there is an increased likelihood of noise in the scan driver due to the high voltage of approximately 150V applied. Furthermore, the impedance of the scan electrode lines causes RC delay, which delays the scan period wherein the high voltage of 150V is applied. In this case, the data signal having a low voltage is rapidly decreased as compared to the scan signal, thereby resulting in back emission.

### SUMMARY OF THE INVENTION

The present invention provides a method of driving an electron emission device that reduces the required withstand voltage of an integrated circuit (IC) constituting a scan driver, thereby reducing both the manufacturing costs of the electron emission device and the likelihood of noise in the scan driver, as well as preventing back emission.

According to an aspect of the present invention, there is provided a method of driving an electron emission device that includes applying a scan signal to a scan electrode line of an electron emission panel during a scan period, and an offset period, which is a non-scan period; applying the data signal from gray-scale information to a data electrode line during a first data period and a second data period of the scan period; wherein the difference between a voltage of the display data signal and a voltage of the scan signal is greater than or equal to a emission start voltage during the first data period, and wherein the voltage difference between the display data signal and the scan signal is less than the emission start voltage during the second data period, wherein the magnitude of the voltage of the scan signal during the offset period is greater than zero volts.

In this way, an offset voltage is applied in a period during which scan signals are not sustained, which reduces the maximum voltage difference experienced by an integrated circuit (IC) constituting a scan driver. Thus, the method of the present invention permits the use less-expensive IC having a lower withstand voltage in an electron emission device, thereby reducing both the manufacturing costs of an electron emission device and the likelihood of noise in the scan driver, as well as preventing back emission.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a waveform diagram of signals applied to anode electrodes, data electrode lines, and scan electrode lines in a conventional method of driving an electron emission device;

FIG. 2 is a schematic block diagram of an electron emission device according to an embodiment of the present invention;

FIG. 3 is a perspective view of an electron emission panel of the electron emission device shown in FIG. 2;

FIG. 4 is a waveform diagram of signals applied to anode electrodes, data electrode lines, and scan electrode lines of an electron emission panel according to an embodiment of the present invention; and

FIG. 5 is a waveform diagram of signals applied to anode electrodes, data electrode lines, and scan electrode lines of an electron emission panel according to another embodiment of the present invention.

### DETAILED DESCRIPTION OF THE INVENTION

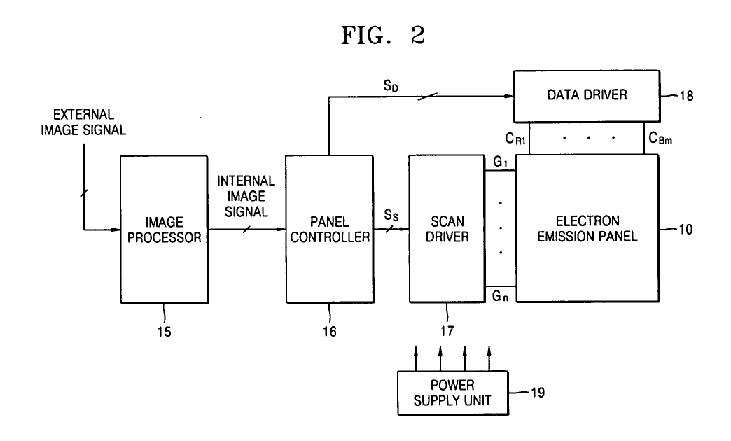

As shown in FIG. 2, an electron emission device includes an electron emission panel 10, as well as the following features for driving the electron emission panel 10: an image processor 15, a panel controller 16, a scan driver 17, a data driver 18, and a power supply unit 19.

Image processor 15 converts an external analog image signal into a digital signal and generates internal image signals like, for example, red (R), green (G), and blue (B) image data, a clock signal, and vertical and horizontal synchronous signals.

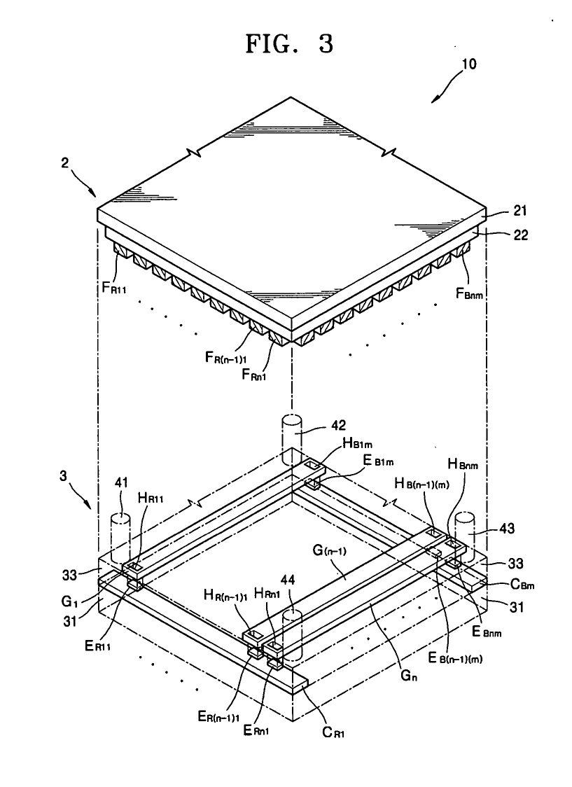

In response to the internal image signals generated by image processor 15, panel controller 16 generates driving control signals S_{D}, a data-driving signal, and S_{S}, a scan-driving signal. Data driver 18 generates a display data signal by processing the data-driving signal S_{D} and applies the display data signal to data electrode lines of electron emission panel 10. Looking at FIG. 3, the data electrode lines may be connected to cathode electrode lines C_{R1} to C_{Bm} or gate electrode lines G₁ to Gₙ. FIG. 3 shows m number of cathode electrode lines, wherein the electron emission panel includes a red subpixel comprising cathode electrode lines C_{R1} to CR₍ₘ₁₎, and a blue subpixel starting at C_{Bm}. Furthermore, FIG. 3 shows n number of gate electrode lines, wherein the electron emission panel includes gate electrode lines G₁ to Gₙ. Scan driver 17 processes the scan-driving signal S_{S} and applies the processed scan-driving signal S_{S} to scan electrode lines of the electron emission panel 10. Like the data electrodes, the scan electrode lines may be connected to either gate electrode lines G₁ to Gₙ or cathode electrode lines C_{R1} to C_{Bm}.

Power supply unit 19 applies a predetermined amount of power to image processor 15, panel controller 16, scan driver 17, data driver 18, and an anode electrode 22 of electron emission panel 10.

Referring to FIG. 3, electron emission panel 10 includes a front panel 2 and a rear panel 3, which are supported by space bars 41, 42, 43, and 44.

Rear panel 3 includes a rear substrate 31, cathode electrode lines C_{R1} to C_{Bm}, electron emission sources E_{R11} to E_{Bnm}, an insulating layer 33, and gate electrode lines G₁ to Gₙ. Each electron emission source corresponds to an intersection of a gate electrode line and a data electrode line. Thus, E_{R11} corresponds to the intersection of gate electrode line G₁ and cathode electrode line C_{R1}.

Cathode electrode lines C_{R1} to C_{Bm}, which act as data electrode lines, are electrically connected to the electron emission sources E_{R11} to E_{Bnm}. Through holes H_{R11} to H_{Bnm}, each of which corresponds to one of the electron emission sources E_{R11} to E_{Bnm}, are formed in the insulating layer 33 and the gate electrode lines G₁ to Gₙ. Thus, like the electron emission sources, through holes H_{R11} to H_{Bnm} are formed where the gate electrode lines and the cathode electrode lines intersect one another.

Front panel 2 includes a front transparent substrate 21, an anode electrode 22, and phosphor cells F_{R11} to F_{Bnm}, each of which correspond to an electron emission source and through hole. A high positive-polarity potential ranging from 1 KV to 4 KV is applied to anode electrode 22 to attract electrons emitted from the electron emission sources E_{R11} to E_{Bnm} so that the emitted electrons move towards the phosphor cells F_{R11} to F_{Bnm}.

In operation, a first high voltage is applied to the gate electrodes, acting as scan electrode lines G₁ to Gₙ, and a second voltage is applied to the cathode electrodes, acting as data electrode lines, C_{R1} to C_{Bm}. The difference between the voltages is equal to or larger than an emission start voltage that results in the emission of electrons from the cathode electrodes. A high positive polarity is applied to the anode electrode 22, which attracts the emitted electrons so that they collide with phosphor cells formed in front of the anode electrode, and light is emitted.

In addition, although an electron emission panel having a general structure in which gate electrodes are disposed above the cathode electrodes is illustrated in FIG. 3, it should be noted that the present invention can be applied to an electron emission panel having a structure in which gate electrodes are disposed below the cathode electrodes.

Moreover, although the electron emission panel 10 illustrated in FIG. 3 shows cathode electrodes C_{R1} to C_{Bm} serving as data electrode lines, and the gate electrodes serving as scan electrode lines G₁ to Gₙ, it is evident that the present invention is applied to the opposite case as well, wherein gate electrodes G₁ to Gₙ serve as data electrode lines and cathode electrodes C_{R1} to C_{Bm} serve as scan electrode lines.

By using a method of driving an electron emission device including an electron emission panel similar to the one described above, wherein pulse widths (using PWM) or pulse amplitudes (using PAM) of the display data signals are changed according to gray-scale information in the image data, the brightness of light output from the electron emission panel can be controlled.

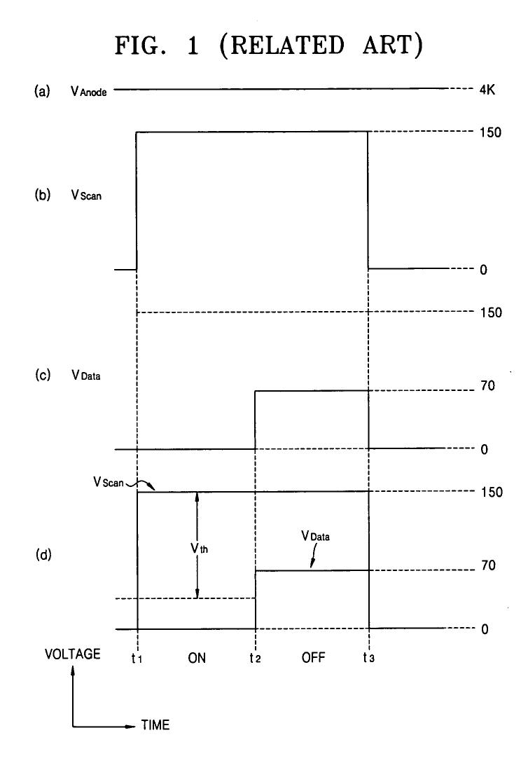

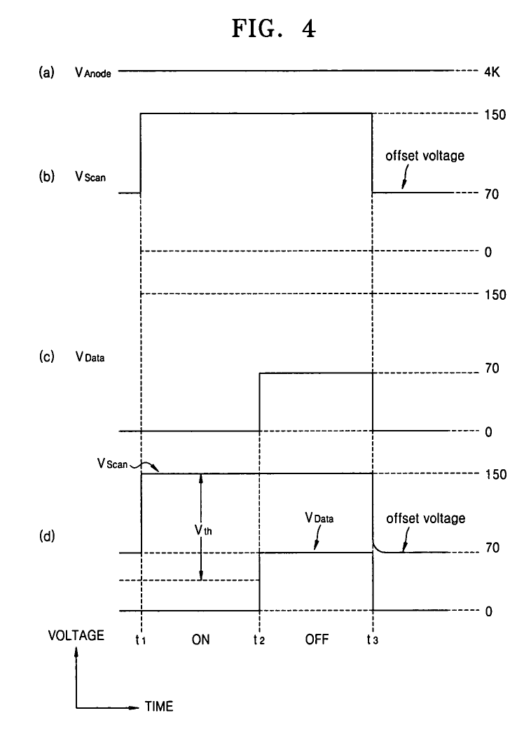

In FIG. 4 at (a), V_{Anode} shows a voltage applied to anode electrodes disposed in an uppermost portion of an electron emission panel. As in the conventional method shown in FIG. 1, a very strong positive-polarity voltage of 4 KV is applied to the anode electrodes to attract electrons emitted from the rear panel 3.

In FIG. 4 at (b) is a waveform diagram of a scan signal applied to scan electrode lines of an electron emission panel. The scan signal has a pulse voltage V_{Scan}, wherein a high voltage pluse of 150V is applied to the scan electrode lines during a scan period of t₁ to t₃, and an offset voltage is applied during the non-scan, or offset, period. An offset voltage of 70V is illustrated in FIG. 4.

In FIG. 4 at (c) is a waveform diagram of a display data signal applied to data electrode lines of an electron emission panel. The display data signal has a pulse voltage V_{data} of 0V in the first period of the scan period, t₁ to t₂, and a high level voltage of 70V in the second period of the scan period, t₂ to t₃.

FIG. 4 at (d) simultaneously shows both the waveform of the scan signal from (b) and the waveform of the display data signal from (c). As in FIG. 1, Vₜₕ is the emission start voltage at which electron emission begins. During the first data period (t₁ to t₂), or on period, the difference in the pulse voltages (V_{scan}(150 v)−V_{Data}(0V)) exceeds the emission start voltage Vₜₕ. During the second data period (t₂ to t₃), or off period, the difference between the pulse voltages (V_{scan}(150 v)−V_{Data}(70V)) is less than the emission start voltage Vₜₕ.

In the method of driving the electron emission panel according to an embodiment the present invention, a scan driver continually maintains at least a voltage equal to or larger than the offset voltage. This means an integrated circuit (IC) constituting the scan driver is required only to have a withstand voltage based on the difference between the offset voltage (70V) and a maximum driving voltage (150V), i.e., 80V. Therefore, the maximum required withstand voltage of the IC is only 96V, which 120% of the maximum expected voltage difference in the scan driver.

Thus, compared to a conventional method for driving an electron emission device which required the scan driver to have a withstand voltage of 180V, the method of the present invention for driving an electron emission device allows a less-expensive IC to be used as a scan driver that has a maximum withstand voltage of 96V. Accordingly, manufacturing costs for the electron emission device can be substantially reduced.

In addition, since the potential voltage difference in the IC for scan driving is only 80V, the likelihood of noise is noticeably reduced. Further, RC delay caused by an impedance of the scan electrode lines is reduced, and since a difference between a voltage in the scan period of the scan signal and a low voltage of the display data signal in the offset period, which is the non-scan period, is lower than the emission start voltage back emission does not occur.

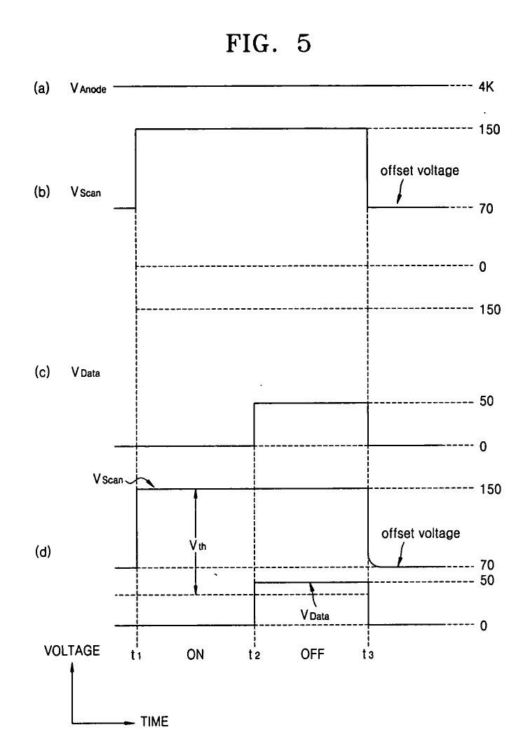

In this embodiment, the offset voltage of the scan signal in the offset period is 70V, which is the same as a voltage of the display data signal in the second data period, wherein electrons are not emitted. In another embodiment of the present invention shown in FIG. 5, however, V_{scan} during the offset period may be larger than V_{data} during the second data period.

The waveform diagrams of FIG. 5 are almost the same as the waveform diagrams of FIG. 4. But in FIG. 5 at (c) and (d), a voltage V_{Data} of 50V is applied during the a second data period, which is less than than the 70V offset voltage. Reducing V_{data} during the second data period increases the overall power efficiency of the electron emission device.

The difference between V_{scan} and V_{data} during the second data period, or off period, should be less than the emission start voltage. Accordingly, if V_{scan} during the scan period is 150V and the emission start voltage is 120V, then V_{Data} during the second data period, or off period, should be larger than 30V.

The invention can also be implemented as computer readable codes on a computer readable recording medium. The computer readable recording medium is any program or data storage device that can store data that can be thereafter read by a computer system. Examples of computer readable recording media include read-only memory (ROM), random-access memory (RAM), CD-ROMs, magnetic tapes, floppy disks, flash memories, or optical data storage devices. A program is defined as a series of instruction commands that are directly or indirectly used in a device having an information processing capability, such as a computer, so as to obtain specific results. Thus, the term “computer” is used to mean all devices that include memories, input/output units, and operating units and have an information processing capability required for performing specific functions using programs. Even a device for driving an electron emission panel that is just limited to its use for panel driving and in its entity, may be considered as a kind of computer.

Moreover, the invention can also be made using a schematic or VHDL on a computer, connected to a computer or embodied by a programmable IC like, for example, a field programmable gate array (FPGA). The recording medium that can be used to store a program for executing the method includes a programmable IC or a memory device.

As described above, the method of driving the electron emission device according to the present invention has the following advantages. First, a maximum withstand voltage of an IC used for scan driving can be substantially reduced. Since a low withstand voltage IC is generally less-expensive, manufacturing costs for an electron emission device can be noticably reduced. Second, as the smaller potential difference in voltage experienced by the IC for scan driving reduces the likelihood of noise in the scan driver, the overall system stability is increased. Third, RC delay caused by an impedance of the scan electrode lines is reduced, and the difference in V_{scan} between the scan period and the offset period is lower than an emission start voltage such that back emission is prevented.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. A method for driving an electron emission device comprising:
applying a scan signal to a scan electrode line of an electron emission panel during a scan period and an offset period, which is a non-scan period;
applying a display data signal from gray-scale information to a data electrode line of the electron emission panel during a first data period and a second data period of the scan period;
wherein a difference between a voltage of the display data signal and a voltage of the scan signal is greater than or equal to an emission start voltage during the first data period, and
wherein the difference between the voltage of the display data signal and the voltage of the scan signal is less than the emission start voltage during the second data period,
wherein the magnitude of the voltage of the scan signal during the offset period is greater than zero volts.

2. The method of claim 1, wherein a difference between the voltage of the scan signal during the scan period and the voltage of the scan signal during the offset period is less than the emission start voltage.

3. The method of claim 1, wherein the voltage of the scan signal during the offset period is the same as the voltage of the display data signal during the second data period.

4. The method of claim 3, further comprising providing a recording medium on which a program for executing the method on a computer is recorded.

5. The method of claim 4, wherein magnitude of the voltage of the display data signal during the second data period is greater than zero volts.

6. The method of claim 1, further comprising providing a recording medium on which a program for executing the method on a computer is recorded.

7. The method of claim 1, wherein the magnitude of the voltage of the display data signal during the second data period is greater than zero volts.

8. The method of claim 1, wherein the voltage of the scan signal during the offset period is greater than the voltage of the display data signal during the second data period.

9. The method of claim 8, further comprising providing a recording medium on which a program for executing the method on a computer is recorded.

10. The method of claim 9, wherein the magnitude of the voltage of the display data signal during the second data period is greater than zero volts.

11. A device for driving an electron emission device comprising:
a scan driver that applies a scan signal to a scan electron line of an electron emission panel during a scan period and an offset period, which is a non-scan period; and
a data driver that applies a data display signal from gray-scale information to a data electrode line of the electron emission panel during a first data period of the scan period such that the difference between a voltage of the data display signal and a voltage of the scan signal is greater than or equal to an emission start voltage, and
wherein the data driver applies the data display signal to the data electrode line during a second data period of the scan period such that the difference between the voltage of the data display signal and the voltage of the scan signal is less than the emission start voltage,
wherein the magnitude of the voltage of the scan signal during the offset period is greater than zero volts.

12. The device of claim 11, wherein a difference between the voltage of the scan signal during the scan period and the voltage of the scan signal during the offset period is less than the emission start voltage.

13. The device of claim 11, further comprising a recording medium on which a program that instructs a computer to perform driving of the electron emission device is recorded.
